(19) United States
(12) Patent Application Publication
(10) Pub. No.: US 2015/0153561 A1
(43) Pub. Date: Jun. 4, 2015

(54) Glass Structure Disposed in Frame of Sight and Manufacturing Method Thereof

(71) Applicants: Sintai Optical (Shenzhen) Co., Ltd., Shenzhen City (CN); Asia Optical International Ltd., Tortola (GB)

(72) Inventor: Chun-Chieh Wang, Taichung (TW)

(21) Appl. No.: 14/555,753

(22) Filed: Nov. 28, 2014

(30) Foreign Application Priority Data
Nov. 29, 2013 (TW) 102143678

(51) Int. Cl. G02B 23/00; C03C 17/34; C03C 15/00

(52) U.S. Cl. CPC G02B 23/00; C03C 15/00; C03C 17/34; B29L 2011/00

(57) ABSTRACT

A glass structure disposed in a frame of a sight. The glass structure includes a lens disposed in the frame and being at least 1 mm in thickness, a micro structure being formed at a center of a surface of the lens and 1.5 μm deep from the surface, and a compound is filled in the micro structure; and at least one light source disposed on an edge of the lens, wherein light from the light source enters the lens and travels to the micro structure, and the compound absorbs the light and emits fluorescent light to display pattern of the micro structure.

### BACKGROUND OF THE INVENTION

1. Field of the Invention

The invention relates to a glass structure disposed in a frame of a sight and a manufacturing method thereof, and more particularly to a glass structure having a sight mark capable of emitting fluorescent light and a manufacturing method thereof.

2. Description of the Related Art

Conventional sights such as rifle sights generally have a glass structure equipped with a sight mark consisting of black lines which are not visible in the night.

### BRIEF SUMMARY OF THE INVENTION

The object of the invention is to provide a glass structure disposed in a frame of a sight. A reticle is formed on the glass by etching, and a compound is filled into the reticle. When light emits the reticle filled with the compound, the compound absorbs the light and emits fluorescent light to display pattern of the micro structure. Therefore, the reticle is visible even in a dark environment.

The invention provides a glass structure disposed in a frame of a sight. The glass structure in accordance with an exemplary embodiment of the invention includes a lens disposed in the frame and being at least 1 mm in thickness, a micro structure being formed at a center of a surface of the lens and 1.5 μm deep from the surface, and a compound is filled in the micro structure; and at least one light source disposed on an edge of the lens, wherein light from the light source enters the lens and travels to the micro structure, and the compound absorbs the light and emits fluorescent light to display pattern of the micro structure.

The invention also provides a manufacturing method for a glass structure disposed in a frame of a sight. The manufacturing method in accordance with an embodiment includes the following steps: providing a glass substrate having a thickness of at least 1 mm; exposing and etching a surface of the glass substrate to form a plurality of micro structures having a depth of at least 1.5 μm from the surface; dividing the glass substrate into a plurality of lenses in such a manner that each micro structure is located at a center of each lens; forming a plane on an edge of each lens; filling a compound into the micro structures; coating an opaque material on the edge of each lens except the plane; and mounting the lens on the frame in such a manner that the plane corresponds to a light source.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section of a sight of the invention;

FIG. 2A is a top view of a lens of a sight of the invention;

FIG. 2B is a side view of a lens of a sight of the invention in direction A;

FIG. 2C is a side view of a lens of a sight of the invention in direction B; and

FIG. 3 is a flow chart of a manufacturing method of a sight of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

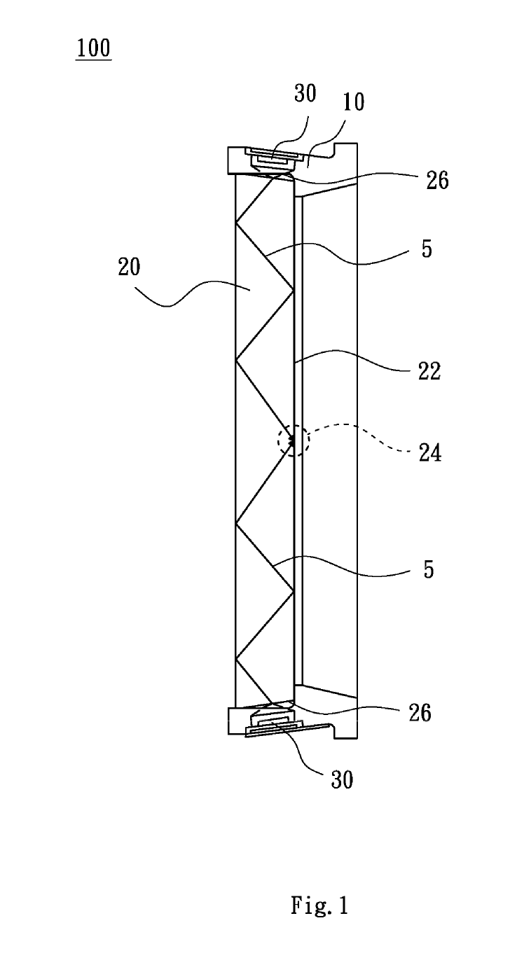

Referring FIG. 1, a sight of the invention includes a frame 10, a lens 20 and a plurality of light sources 30.

The lens 20 is a circular lens and has a surface 22, a micro structure 24 and a compound. The micro structure 24 is formed on the surface 22 by etching. The micro structure 24 is depressed on the surface 22 and has a specific pattern, such as a cross. The lens 20 further has a plurality of edges. Two of the edges are inclined planes 26. The lens 20 is mounted in the frame 10. Two light sources 30, such as light emitting diode, are mounted on the frame 10. Light from the light source 30 enters the lens 20 through the planes 26, travels along a path 5 by total reflections between two surfaces of the lens 20, and finally reaches the micro structure 24. Because the compound (scattering diluent) is filled in the micro structure 24, even in a dark environment, the micro structure 24 absorb the light from the light source 30 and emits fluorescent light. In this embodiment, the compound includes titanium dioxide (TiO₂).

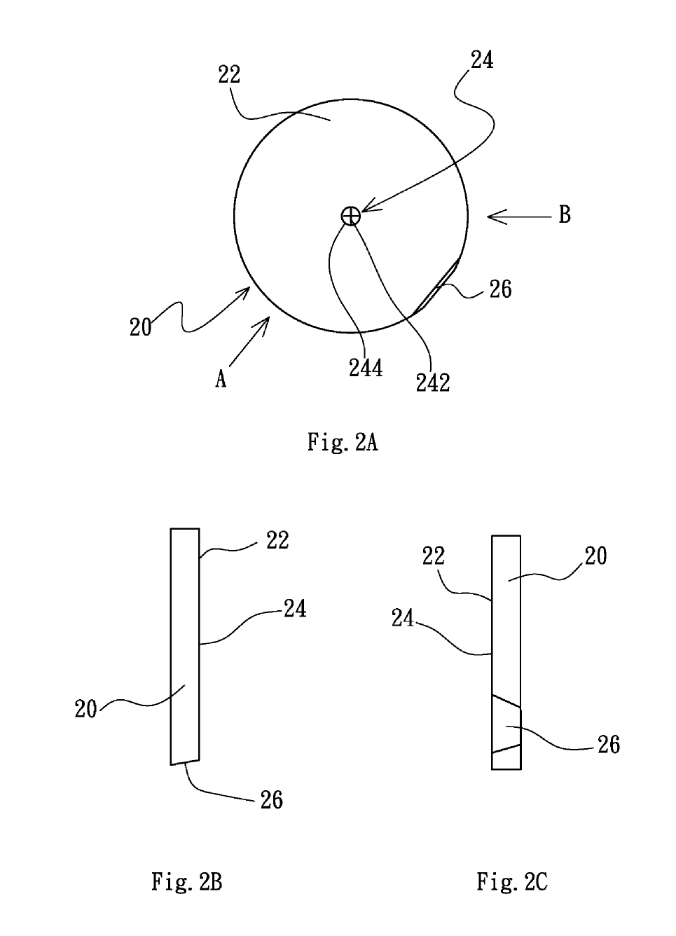

Referring to FIGS. 2A-2C, the lens 20 is a circular lens. The specific pattern formed at a center of the lens 20 includes a reticle 242 of cross shape and aiming mark 244 of circular shape. The compound is filled into the reticle 242 and the aiming marks 244. As shown in FIGS. 2A and 2B, an inclined plane 26 is formed on the periphery of the lens 20. The inclined angle of the plane 26 with respect to the surface 22 can be 80°. Since the inclined plane 26 is formed on the periphery of the lens 20, the plane 26 is a trapezoid when the plane 26 is viewed from one side of the lens 20.

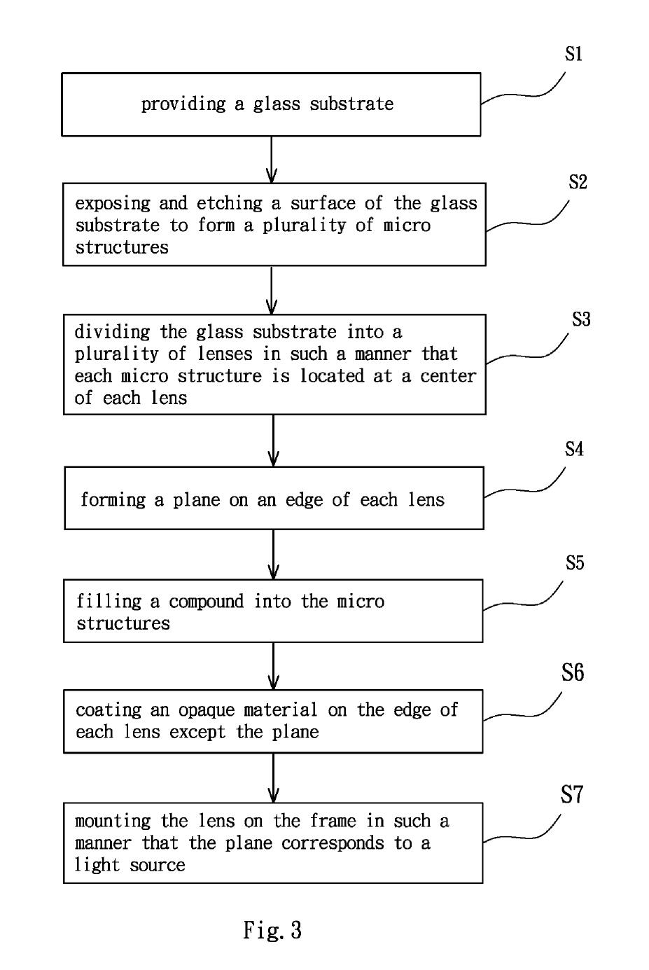

Referring to FIG. 3, a manufacturing method of a sight of the invention is described. In step S1, a glass substrate is provided. The glass substrate has a thickness ranging from 1 mm to 2 mm. The micro structures are formed on the glass substrate by exposure, development and etching. The conventional photolithography and etching process is applicable for silicon chip or panel having a thickness ranging from 0.3 mm to 0.6 mm. The photolithography and etching process of the invention is applicable for glass substrate having thickness ranging from 1 mm to 2 mm and cannot be performed on a conventional machine unless the machine is modified. When the thickness of the glass is less than 1 mm, the glass is easy to be broken due to the shock caused by weapon shooting. Therefore, the thickness of the glass is at least 1 mm. In step S2, a plurality of micro structures 24 (including the cross shaped reticle 242 and the circular aiming marks 244) is formed on the lens 20 by the photolithography and etching process of the invention. In step S3, a plurality of marks corresponding to the micro structures are formed on the glass substrate. A cutting machine having image-capture function is used to capture images of the marks so as to position the micro structure and cut out the lenses 20 from the glass substrate in such a manner that each microstructure 24 is located at the center of each lens 20. In step S4, the plane 26 is formed on the periphery of the lens 20 to form an edge of the lens 20 by cutting. In step S5, compound (scattering diluents) is filled into the micro structure 24. In step S6, an opaque material such as black ink is coated on the periphery of lens 20 except the plane 26. Thus, light is difficult to leak out and concentrated to the micro structure for better emitting effect.

In step S7, the lens 20 is mounted to the frame 10 in such a manner that the plane 26 faces the light source 30.

Since the compound (scattering diluents) is filled into the micro structure 24, when light is absorbed by the compound (scattering diluents), the micro structure 24 emits fluorescent light to display the aiming lines 242 and the aiming marks 244. Thus even in a dark environment, the reticle 242 and the aiming marks 244 are visible.

In addition, the micro structure formed by etching has a depth ranging from 1.5 μm to 2 μm. The titanium dioxide is in particle form. The titanium dioxide particles of 5 μm in diameter are grinded to smaller titanium dioxide particles of 1 μm in diameter by a grinding machine. The depth of the micro structure is 1.5 μm. Thus, when a solution containing titanium dioxide particles is introduced into the micro structure, the titanium dioxide particles are stacked to have parts of 0.5 μm outside the micro structure that require to be removed. Therefore, the depth of the micro structure is preferably at least 1.5 μm to perform the micro-structure-filling procedure. The titanium dioxide particle of 1 μm in diameter is suitable to be filled into the micro structure of the depth. When light is absorbed by the titanium dioxide particle, the titanium dioxide particle emits fluorescent light to display the aiming lines 242 and the aiming marks 244.

What is claimed is:

1. A glass structure for a frame of a sight, comprising:
a lens which is disposed in the frame and comprises a surface, a micro structure formed at a center of the surface, and a compound filled in the micro structure, wherein the lens is at least 1 mm in thickness, and the micro structure is at least 1.5 μm deep from the surface; and
at least one light source disposed on an edge of the lens, wherein light from the light source enters the lens and travels to the micro structure, and the compound absorbs the light and emits fluorescent light to display a pattern of the micro structure.

2. The glass structure as claimed in claim 1, wherein the lens is at most 2 mm in thickness.

3. The glass structure as claimed in claim 1, wherein the micro structure is at most 2 μm.

4. The glass structure as claimed in claim 1, wherein the micro structure is depressed by etching.

5. The glass structure as claimed in claim 1, wherein the micro structure is cross-shaped.

6. The glass structure as claimed in claim 1, wherein the lens further comprises a plurality of edges, and one of the edges is a plane through which light from the light source enters the lens.

7. The glass structure as claimed in claim 6, wherein the plane is an inclined plane of a trapezoid.

8. The glass structure as claimed in claim 6, wherein the edges of the lens except the plane are coated by an opaque material.

9. The glass structure as claimed in claim 8, wherein the opaque material comprises black ink.

10. The glass structure as claimed in claim 1, wherein the light source

11. The glass structure as claimed in claim 1, wherein the compound comprises titanium dioxide.

12. A manufacturing method for a glass structure disposed in a frame of a sight, comprising:
providing a glass substrate having a thickness of at least 1 mm;
exposing and etching a surface of the glass substrate to form a plurality of micro structures having a depth of at least 1.5 μm from the surface;
dividing the glass substrate into a plurality of lenses in such a manner that each micro structure is located at a center of each lens;
forming a plane on an edge of each lens;
filling a compound into the micro structures;
coating an opaque material on the edge of each lens except the plane; and
mounting the lens on the frame in such a manner that the plane corresponds to a light source.

13. The manufacturing method as claimed in claim 12, wherein the thickness of the glass substrate is at most 2 mm.

14. The manufacturing method as claimed in claim 12, wherein the depth of each micro structure is at most 2 μm.

15. The manufacturing method as claimed in claim 12, wherein the compound comprises titanium dioxide.

16. The manufacturing method as claimed in claim 15, wherein the titanium dioxide is in particles, and the manufacturing method further comprising providing a grinding machine to reduce diameters of the particles from 5 μm to 1 μm.

17. The manufacturing method as claimed in claim 12 further comprising:
forming a plurality of marks on the glass substrate corresponding to the micro structures;
providing a cutting machine capable of image capture;
capturing images of the marks to position the micro structures; and
cutting out the lenses from the glass substrate by the cutting machine.

18. The manufacturing method as claimed in claim 12, wherein the plane is an inclined plane of a trapezoid.

19. The manufacturing method as claimed in claim 12, wherein the opaque material comprises black ink.

20. The manufacturing method as claimed in claim 12, wherein the micro structure is cross-shaped.
